(19) United States
(12) Patent Application Publication
(10) Pub. No.: US 2006/0195506 A1
(43) Pub. Date: Aug. 31, 2006

(54) Simplified scheme of mobile to mobile rich content messaging

(76) Inventor: Li Deng, San Jose, CA (US)

Correspondence Address: Li Deng, 1047 S. Blaney Ave, San Jose, CA, 95129, US

(21) Appl. No.: 11/067,049

(22) Filed: Feb. 26, 2005

(51) Int. Cl. G06F 15/16

(52) U.S. Cl. 709/203

(57) ABSTRACT

A method, client and server are directed at providing a simplified scheme for delivering multimedia messages from mobile to mobile via wireless networks and internet. The multimedia can be either resident on mobile devices or stored in a multimedia database on a server. The present invention provides a server that receives and stores uploaded multimedia; generates a unique id and a link for accessing the multimedia message; collects mobile device info from request; converts the multimedia message to formats and dimensions supported by the mobile device; delivers the multimedia message to mobile devices. The present invention also provides a mobile client application that can capture or locate multimedia content on mobile device; upload multimedia messages; formulate and send notification message with an embedded link to other mobile devices via mobile network.

### FIELD OF THE INVENTION

The present invention relates generally to wireless mobile devices with multimedia and wireless internet capabilities, and more particularly but not exclusively to providing a simplified scheme for sending multimedia messages to peers from multimedia capable devices. Multimedia messages such as audio, video, and still images can be either captured on the multimedia devices or selected from a multimedia collection on a network server.

### BACKGROUND OF THE INVENTION

In today's society, mobile devices are becoming increasingly more powerful. The greatest manifestation is the glue between unwired universes to the Internet domain and the advent of wireless multimedia and wireless internet capabilities. The newest versions of mobile wireless devices are capable of capturing full motion video and audio clips, taking pictures. These devices are also capable of displaying high quality color photos, playing mp3, mp4 and other advanced audio clips, and playing back video clips. Those advanced devices are prime candidates for sending and receiving personalized rich content messages.

Mobile phone network infrastructures provide standard ways to deliver multimedia messages. Multimedia Messaging Service (MMS) is used for delivery of rich messaging content (e.g. SMIL, pictures, text combined with images and/or sounds). To send an MMS Message to an end user, an application will have to leverage the MM7 protocol to post a message to Multimedia Messaging Services Center (MMSC). The MMSC is usually run by mobile carriers. To receive the MMS message, mobile devices have to have MMS capabilities with MMS service enabled and activated with the carriers.

Currently, a lot of handsets out there are not MMS capable. Even for users with MMS capable phones, sending or receiving rich content messages using MMS protocol is still expensive. Furthermore, the interoperability of MMS among different carriers is a formidable roadblock. It is impossible to send a picture message from a camera phone to another phone with a different carrier. The potential of mobile to mobile multimedia messaging is vastly under tapped due to these issues. The present invention aims at providing a simplified scheme for enabling the inter-carrier mobile to mobile delivery of multimedia messages. By taking advantages of wide availability of SMS and WAP services on mobile devices and universal interoperability of standard mobile network services such as SMS among carriers, the system and method of the present invention offers a complimentary scheme that greatly broadens the reaches of mobile to mobile multimedia messaging. The present invention will make it possible for users to send rich content messages to SMS and WAP services enabled mobile devices regardless of the carriers. The present invention in conjunction with MMS service will make mass market mobile to mobile multimedia messaging a reality.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows a functional block diagram illustrating one embodiment of mobile client software for practicing the invention.

FIG. 3 shows a functional block diagram illustrating one embodiment of server components that may be included in a system implementing the invention;

FIG. 4 illustrates a logical flow diagram generally showing one embodiment of a simplified scheme for mobile users to capture audio, video, and still images and then send the captured multimedia clips to peers from multimedia capable devices.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

The terms “comprising,” “including,” “containing,” “having,” and “characterized by,” refer to an open-ended or inclusive transitional construct and does not exclude additional, un recited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

The term “or” is an inclusive “or” operator, and includes the term “and/or,” unless the context clearly dictates otherwise.

The phrase “in one embodiment,” as used herein does not necessarily refer to the same embodiment, although it may.

The term “based on” is not exclusive and provides for being based on additional factors not described, unless the context clearly dictates otherwise.

Briefly stated, the present invention is directed towards a client, server, and a method providing a simplified scheme to enable mobile phone users to conduct peer to peer one to one, and one to many rich content messaging from their multimedia capable mobile phones. The rich content may also be stored on a server database or on the mobile device. A mobile client application is implemented to practice the present invention. The rich content may be captured, recorded, and stored in a mobile device by the mobile client application running on the mobile phone. If the rich content elements are located on a server store, a browse and/or search function may be provided for users to select the desired content using the mobile client application. The user must specify the mobile device number for each recipient of the rich content message using the mobile client application. In one embodiment, mobile device number is the mobile phone number. The current invention may be integrated with address book application. Users may select one or multiple recipients from their personal address books. Each entry of address book contains at least one piece of info: mobile device number.

Upon a request from the mobile user to send a multimedia content on mobile device, the mobile client application running on the mobile device first uploads the multimedia content to a server. The uploaded rich content will then be saved on the server. For each multimedia message uploaded, a unique id is generated using any of a variety of mechanisms, including a counter, a MD5 hash, and the like. The server also generates a link including the unique id for accessing the multimedia message. The link, such as a Uniform Resource Locator (URL), a script, an executable, a program, a location string and the like, may be used to access the multimedia message on the server. The server then returns the link that includes the unique id to the mobile client application. In one embodiment, the link is the URL that points to the location of the multimedia message on the saver. The mobile client application may send the recipient's mobile phone numbers to server for authentication purpose. The server may also associate the targeted mobile devices with the unique id and may store the association for future security validation.

The mobile client application generates a notification message that embeds the link received from the server. The link can be invoked from mobile device that has WAP services to retrieve the multimedia message. The notification message will be delivered as a SMS, browser alert, net alert, WAP push, and the like directly by the mobile client application to the targeted mobile devices through mobile networks. The mobile device that receives the notification message can then retrieve the multimedia message by invoking the link or action embedded in the notification message. Due to the universal interoperability of SMS, browser alert, net alert, WAP push, and the like, the notification message can be sent to any device regardless of the carrier. Therefore, the present invention enables mobile phone users to send or receive mobile to mobile rich content messages among different service providers. The present invention completely eliminates the need to talk to carrier's MMSC. By eliminating the need to pass messages through carrier's MMSC, present invention enables mobile phones without MMS capability or MMS service enabled to send or receive multimedia messages.

By invoking the link or the action embedded in the notification message, mobile device sends a request to the web server. Upon receiving the request from the mobile device, the server collects the information about the mobile device via user agent profile and HTTP headers and the like on the fly. The collected information may include, but not limited to, mobile device model, MIN, user agent, User Agent Profile, requesting IP and the like. The server also gets the unique id of a rich content item as part of the request from the mobile device. In one embodiment where the recipient mobile device may need to be authenticated, the mobile user will be asked to enter the device number at the time of retrieving the rich content item. Once the device number is received by the server, the server will validate the device number against the saved association between unique id and the device numbers. If the device is authenticated, the rich content item will be delivered to the mobile device. Otherwise, the request will be rejected.

More information about the particular mobile device will be queried from a mobile device database. This information includes, but not limited to, the supported rich content formats, the display dimensions, and the like. The server then converts rich content item to the formats supported by the mobile device if needed. This process may require the resizing of the image or video elements. The server will deliver the resized/converted/formatted multimedia message to the mobile device as requested.

Upon receiving the multimedia message on mobile device, the mobile user can read the rich content message. The user also has the option to play, download and save the audio, video, and image embedded in the rich content message.

In another embodiment, the present invention offers a way to send rich content message to a group of recipients. In this case, multiple mobile device numbers have to be specified by the sender. The same notification message with an embedded link will be sent to the multiple mobile devices associated with the specified mobile device numbers.

Illustrative Operating Environment

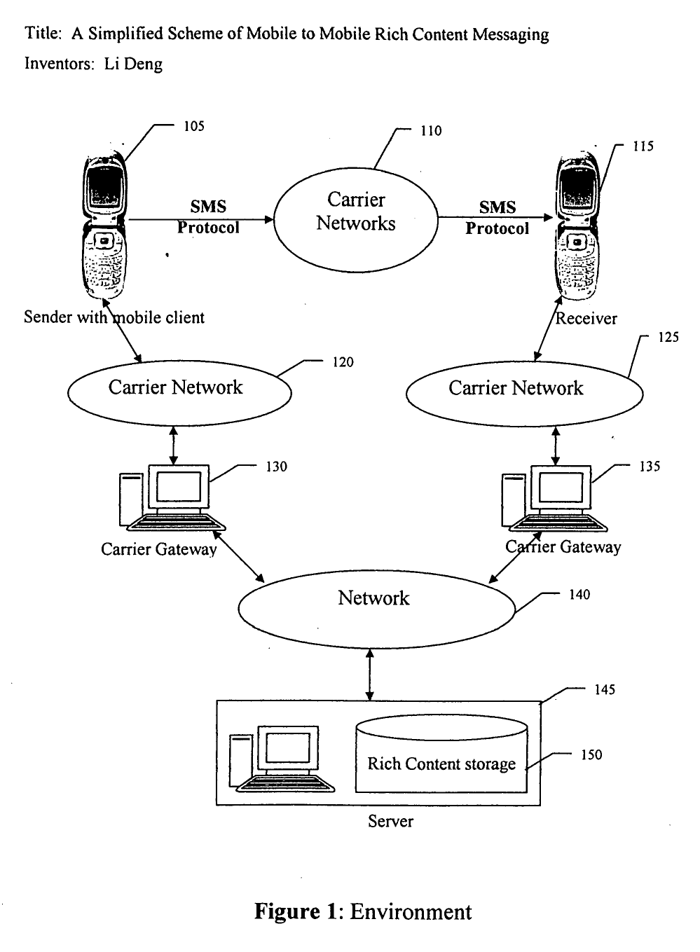

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, diagram 100 includes mobile device 105 and its peer 115, carrier network 110, 120, 125, carrier gateway 130, 135, network 140, Web Server 145, and rich content store 150. Mobile device 105 is in communication with its peer 115 through carrier network 110. Carrier network 120 is in communication with mobile device 105 and Carrier Gateway 130. Similarly, Carrier network 125 is in communication with mobile device 115 and Carrier Gateway 135. Network 140 is in communication with and enables communication between carrier gateway 130, 135, Web Server 145, and rich content store 150.

Generally, mobile device 105 may include virtually any portable computing device capable of connecting to another computing device to send and receive a message. Mobile device 105 may also include other devices, such as Personal Digital Assistants (PDAs), microprocessor-based or programmable consumer electronics, wearable computers, and the like. As such, mobile devices typically range widely in terms of capabilities and features. For example, a web-enabled mobile device may have a touch sensitive screen, a stylus, and several lines of color LCD display in which both text and graphics may be displayed. Moreover, the web-enabled mobile device may include a mobile browser application enabled to receive and to send wireless application protocol messages (WAP), and the like. In one embodiment, the mobile browser application is enabled to employ WAP to fetch and display mobile markup languages such as Handheld Device Markup Language (HDML), Wireless Markup Language (WML), WMLScript, XHTML Mobile Profile, and the like.

Mobile device 105 may include a keyboard, mouse, speakers, a microphone, and an area on which to display information. Mobile device 105 may further include low-end devices that may have limited storage memory, reduced application sets, low bandwidth for transmission of a communication, and the like.

Mobile device 105 may provide a message, network packet, and the like, that includes a device identifier, such as a Mobile Identification Number (MIN). MINs are provided with each WAP request and uniquely identify each handset. Mobile device 105 may further provide a device number in addition to the device identifier. In one embodiment, mobile device 105 includes a device identification component configured to provide the MIN, phone number, and the like.

Mobile device 105 may be configured to capture multimedia clips such as audio, video, and pictures. The captured multimedia is then uploaded to Web Server 145 and saved into rich content store 150 for delivering to peer mobile device 115. Mobile device 105 may also be configured to browse multimedia collection saved in rich content store 150 and pick up items from the rich content store for delivery to peer mobile device 115. Web server 145 may be configured to generate a unique id for uploaded multimedia or the multimedia item picked up from the rich content store. Web server 145 may be configured to return a link to mobile device 105. The link, such as a Uniform Resource Locator (URL), a script, an executable, a program, a location string and the like, may be used to access the multimedia message on the server. In one embodiment, the link is the URL that points to the location of the multimedia message on the saver.

The link may further include a unique id associated with a multimedia message stored on the server. The unique id may be generated based on any of a variety of mechanisms, including, but not limited to a counter, a MD5 hash, and the like. Web Server 145 may employ a mapping store (not shown) to save the mapping, i.e. the unique id and the location of the rich content multimedia.

Mobile device 105 may be configured to send a notification message, such as through a Short Message Service (SMS), Multimedia Message Service (MMS), browser alert, net alert, WAP push, and the like, to other mobile device, such as mobile device 115, and the like. In one embodiment, the message includes a link, such as a URL, script, executable, program, and the like. The link contains the unique id the Mobile device 105 received from the Web Server 145. Mobile device 115 may be configured to employ the link to request access to another piece of info, such as from Web server 145, and the like. In one embodiment, the other info is a multimedia message. Multimedia, and virtually any other content type, and the like, may be accessible through the included URL, script, executable, program, and the like. For example, the content may include, but not be limited to, a document that contains multiple audio files, video files, graphics files and the like.

Mobile device 105, 115 may further include a mobile client application, and the like, that is configured to manage the actions described above for mobile device 105, 115.

Carrier network 110, 120, 125 are configured to couple mobile device 105, 115 and their components with carrier gateway 130, 135. Carrier network 110, 120, 125 may include any of a variety of wireless sub-networks that may further overlay stand-alone ad-hoc networks, and the like, to provide an infrastructure-oriented connection for mobile device 105. Such sub-networks may include mesh networks, Wireless LAN (WLAN) networks, cellular networks, and the like.

Carrier network 110, 120, 125 may further include an autonomous system of terminals, gateways, routers, and the like connected by wireless radio links, and the like. These connectors may be configured to move freely and randomly and organize themselves arbitrarily, such that the topology of carrier network 120, 125, 110 may change rapidly.

Carrier network 110, 120, 125 may further employ a plurality of access technologies including, but not limited to, 2nd (2G), 2.5 (2.5G), 3rd (3G) generation radio access for cellular systems, WLAN, Wireless Router (WR) mesh, and the like. Access technologies such as 2G, 2.5G, 3G, and future access networks may enable wide area coverage for mobile devices, such as mobile device 105 with various degrees of mobility. For example, carrier network 120 may enable a radio connection through a radio network access such as Global System for Mobile communication (GSM), General Packet Radio Services (GPRS), Enhanced Data GSM Environment (EDGE), Code Division Multiple Access (CDMA), Code Division Multiple Access 2000(CDMA 2000), Wideband Code Division Multiple Access (WCDMA), and the like. In essence, carrier network 120, 125 may include virtually any wireless communication mechanism by which information may travel between mobile device 105, 115 and carrier gateway 130, 135.

Carrier gateway 130, 135 may include any computing device capable of connecting with mobile device 105, 115 to enable communications with another computing device, such as Web Server 145, PC desktop (not shown), and the like. Such devices that may operate as carrier gateway 130, 135 include, but are not limited to, personal computers, desktop computers, multiprocessor systems, microprocessor-based or programmable consumer electronics, network PCs, servers, and the like.

Carrier gateway 130, 135 typically includes a carrier level service provider's computing device, and related infrastructure. Carrier gateway 130, 135 may be configured to receive a network packet, and the like, from mobile device 105, 115. The network packet, and the like, may include information associated with mobile device 105, 115, such as a device identifier, and the like. The network packet may further include information associated with an end-user of mobile device 105, 115, such as a user account identifier, and the like. Carrier gateway 130, 135 may include additional information in the network packet prior to sending the network packet towards another device, such as Web Server 145, and the like. The additional information may include carrier information including, but not limited to, a carrier gateway grouping, carrier type, carrier identifier, and the like.

Carrier gateway 130, 135 may further receive a network packet from Web Server 145, and the like. The received network packet may include an SMS message, a mobile browser readable message, and the like.

Network 140 is configured to couple Web Server 145, PC desktop, and the like, with carrier gateway 130, 135. Network 140 is enabled to employ any form of computer readable media for communicating information from one electronic device to another. Also, network 140 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In essence, network 140 includes any communication method by which information may travel between carrier gateway 130, 135, Web Server 145, desktop computing device, and the like.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal.

Web Server 145 may include any computing device capable of connecting to mobile device 105, 115, and the like, to receive a request, process a request, and send response back to the mobile devices and the like. Such devices include personal computers, desktop computers, multiprocessor systems, microprocessor-based or programmable consumer electronics, network PCs, servers, and the like.

Web Server 145 may be configured to receive the request, for example, from mobile devices 105, 115. Web Server 145 may determine whether the intended recipient of the message is configured to receive the message in a mobile browser readable format.

Web Server 145 may store the rich content elements at a location that may be determined based, in part, on user id, file identifier, device number, and the like. In one embodiment, Web Server 145 may store the rich content elements at a server that may be one of a plurality of servers (not shown), or the like.

Illustrative Mobile Client Software

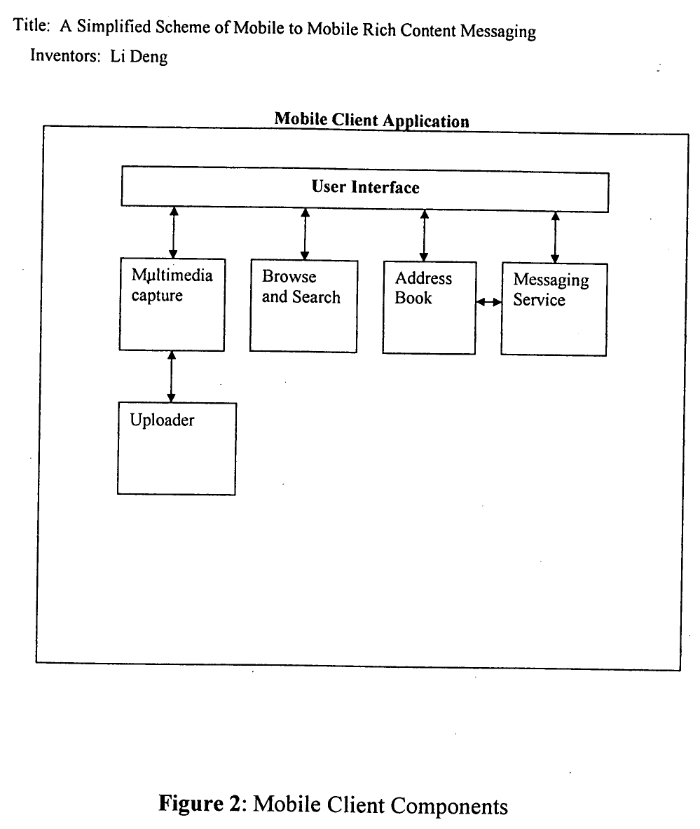

FIG. 2 shows one embodiment of mobile client application of the present invention. Mobile client application may include more or less components than those shown. The components shown, however, are sufficient to disclose an illustrative embodiment for practicing the invention. Mobile client application in FIG. 2 includes a User Interface component, Multimedia capturing component, Multimedia upload component, Messaging Service component, Browse and search component, an optional address book component.

Generally speaking, a mobile user interacts with the mobile client application through the User Interface component. The User Interface component then communicates with different components to accomplish different tasks to enable multimedia messaging. Messaging service component handles the sending of notification messages to other mobile devices through mobile networks.

The image, video, audio capture component of the mobile client application may provide functions for users to capture audio, video, and pictures. The captured multimedia is then uploaded to a server rich content store. A link is then generated and returned to the mobile client application. Mobile users can pick up entries from the address book or enter mobile device numbers to send the multimedia message. The mobile client application then sends a notification message such as a SMS, browser alert, net alert, WAP push, and the like to the targeted mobile devices. In one embodiment, the SMS includes a link received from the server. The recipient device can then request the multimedia message by invoking the link in the notification message.

Illustrative Server Environment

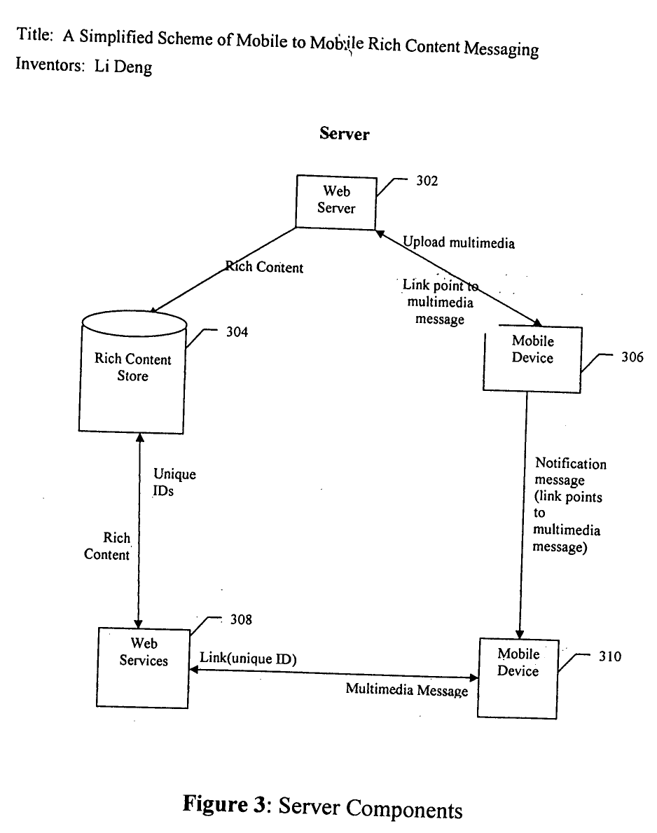

FIG. 3 shows one embodiment of a server, according to one embodiment of the present invention. Server 300 may include many more components than those shown. The components shown, however, are sufficient to disclose an illustrative embodiment for practicing the present invention.

As shown in the figure, the server 300 includes web server 302, rich content Store 304, mobile device 310, web service 308, and mobile device 306. Mobile device 306 is in communication with Web Server 302 and mobile device 310. Web service 308 is in communication with mobile device 310 and rich content store 304.

Web services 308 may operate as a component within Web Server 302, or operate within another computing device. Mobile device 310 may also communicate with Web Services 308 to fetch the multimedia message.

Web Server 302 handles all requests from mobile devices that send multimedia messages. In one embodiment, Web Server 302 is enabled to process requests to upload and store the rich content elements, to deliver multimedia message, to collect the info about mobile device. The uploaded rich content components are saved into the rich content store 304.

Mobile device 306 uploads captured multimedia to Web Server 302. Web server 302 then saves the uploaded multimedia into rich content store 304 for delivery to receiving mobile device 310. Web server 302 then generates a unique id and a link for accessing the multimedia message. Web server 302 then returns the link to mobile device 306. Mobile device 306 then generates a notification message, such as an SMS message, and the like, that includes the link received from Web server 302. The notification message with an embedded link is sent to mobile device 310.

Mobile device 310 sends a request to web service 308, where the request includes the link pointing to the stored multimedia message. Mobile device 310 may also send its device identifier to web service 308.

Web service 308 processes the request for the rich content multimedia message from the mobile device. Web service 308 employs the associated information, including the link, device number, and the like, to access the multimedia message stored in the rich content store 304. The multimedia message can then be delivered by Web service 308 to Mobile device 310.

Generalized Operation

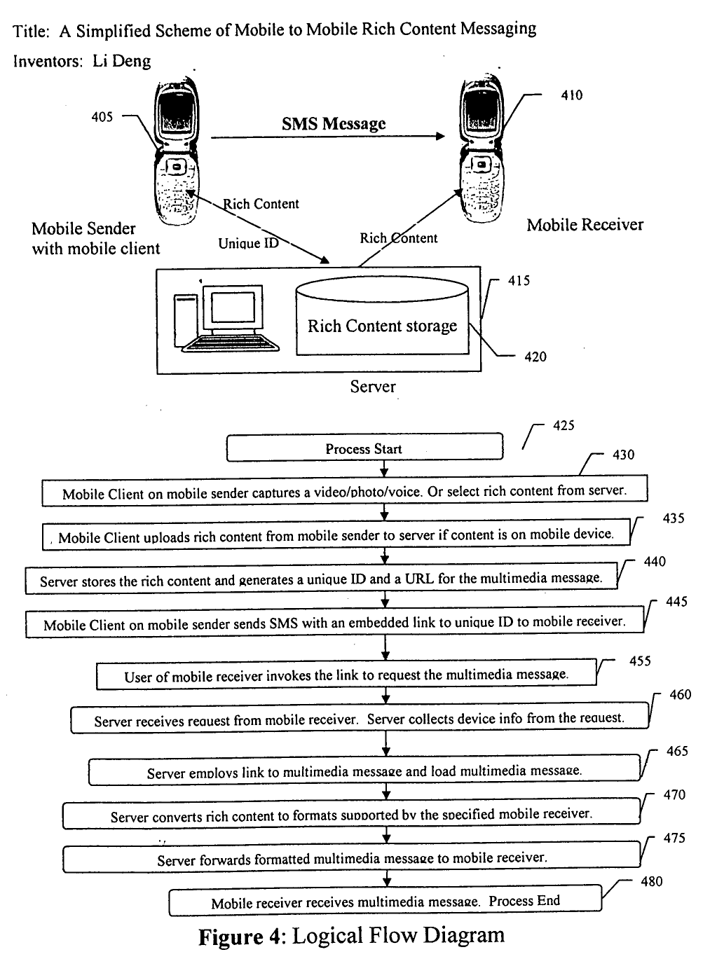

The operation of certain aspects of the present invention will now be described with respect to FIG. 4. FIG. 4 is a flow diagram generally showing one embodiment of a simplified scheme to enable mobile phone users to conduct peer to peer one to one, and one to many rich content messaging from their multimedia capable mobile phones.

For ease of understanding, the process 400 employs an SMS message as the notification message with an embedded URL as the link to access the multimedia message. However, the present invention is not so limited and virtually any messaging vehicle may be employed to deliver the notification, including SMS, net alert, WAP push, browser alert, and the like. Additionally, virtually any link may be employed to enable access to the multimedia message, including a URL, a script, an executable, a program, a location string and the like.

The process 400 begins, after a start block, at block 430, where users may take a picture, record an audio clip, capture a video clip, or browse server multimedia collection to pick up a multimedia content for delivery. The user may also enter text greetings accompanying the multimedia message. The user may then picks up the mobile device numbers from an address book or enters the device numbers, and optionally carrier info about the mobile devices where the multimedia message will be sent.

Processing continues to block 435 where the descriptive text and multimedia content are uploaded into server by the mobile client application and stored on the server. A device number for each recipient in conjunction with carrier info associated with the mobile device may also be forwarded to the server. The device number may be a phone number, and the like. Processing continues to block 440 where a unique id is generated as the identifier for the multimedia content using any of a variety of mechanisms, including a counter, a MD5 hash, and the like. The unique id is mapped via a mapping mechanism to the multimedia content. Server also generates a URL for accessing the multimedia message. The URL is then returned to the mobile client application.

Processing continues to block 445 where the mobile client application generates a notification (SMS) message that embeds the URL received from the server. The URL points to the multimedia message stored on the server. The notification (SMS) message is sent by the mobile client application directly to all the targeted mobile devices via mobile networks.

Upon receiving notification (SMS) message from the sending device, processing continues to block 455 where the mobile user takes the action to request the multimedia message by invoking the URL within the notification (SMS) message.

The processing continues to block 460 where the server receives the request from the mobile device. The server also collects device information from the request on the fly. The server further queries more device information from the mobile device database to find out about the device capabilities and the rich content formats supported by the device. The device information includes, but is not limited to, device model, carrier, supported rich content formats, device screen size, and the like. The mobile device identifier may also be sent to the server along with an HTTP request from the mobile device.

Processing next continues to block 465 as in one embodiment, wherein server uses the unique id embedded in the URL to access the multimedia message. The multimedia message is loaded into memory. The processing then flows to processing block 470, where the server converts the rich content to formats supported by the requesting mobile device. Process block 470 may involves the resizing of the images and videos.

At block 475, the converted and resized multimedia message is delivered to the targeted mobile device. At block 480, the rich content item is received by the mobile device. The multimedia message can be readily viewed, downloaded, saved, and played on mobile device.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A client, server, and method providing a simplified scheme for transmitting multimedia messages from mobile devices to mobile devices, the system and method comprising:
Capturing or locating multimedia clips such as audio, video, and images on the mobile devices;
Browsing and searching a server multimedia collection to select multimedia content from mobile device;
Collecting text message from user on mobile devices;
Establishing from a mobile device connection between the mobile device and a server;
Uploading multimedia message to server using the connection established from the mobile device;
Receiving the uploaded multimedia message from the mobile device at the server;
Generating at the server a unique id for the multimedia message uploaded or selected;
Storing the multimedia message in a multimedia message store at the server;
Generating at the server a link for accessing the stored multimedia message;
Associating the link with the location of the multimedia message in a multimedia store on the server;
Transmitting from the server the link to the mobile device;
Prompting the user to enter recipient device numbers on the mobile device;
Formulating on the mobile device a notification message. The notification message includes the link that points to the stored multimedia message on the server;
Sending notification messages directly from the mobile device to recipient devices via mobile networks;
Sending the mobile device numbers of recipients from the mobile device to server for optional authentication purpose;
Receiving the notification message on a recipient mobile device;
Retrieving the multimedia message by invoking the link embedded in the notification message;
Collecting the recipient device info from mobile request on the fly at the server;
Resizing and reformatting the multimedia message according to mobile device at the server;
Transmitting the reformatted multimedia message to the recipient device from the server.

2. The system of claim 1, wherein a mobile client application further comprising:
Creating content by capturing audio clips, video clips, and still images;
Locating and loading multimedia content from persistent storage on mobile device;
Browsing, searching, and selecting multimedia from a server collection;
Collecting text message from user;
Establishing connection with server;
Uploading multimedia message from mobile device to server;
Sending the mobile device numbers of recipients to server for optional authentication purpose;
Prompting the user to enter recipient device numbers;
Formulating on the mobile device a notification message which includes the link that points to the stored multimedia message on the server;
Sending notification message directly to other devices via mobile networks.

3. The method of claim 1, wherein server offers a multimedia collection by enabling browsing and searching for mobile users to select multimedia content using mobile devices.

4. The method of claim 1, wherein multimedia messages are uploaded by the mobile client application directly from mobile device to server using HTTP connection.

5. The method of claim 1, wherein server software generates a unique id as an identifier for each multimedia message uploaded or selected.

6. The method of claim 1, wherein the uploaded multimedia messages are stored in a multimedia message store.

7. The method of claim 1, wherein server software generates a link including the unique id for accessing multimedia messages.

8. The method of claim 7, wherein the link can be invoked from mobile device to retrieve the multimedia message.

9. The method of claim 7, wherein the link points to multimedia message on the server.

10. The method of claim 7, wherein the link further comprises of a Uniform Resource Locator (URL), a script, an executable, program, a location string, and the like.

11. The method of claim 1, wherein notification messages including the links are sent directly to recipient devices by the mobile client application via mobile networks.

12. The method of claim 11, wherein notification messages are delivered via mobile networks using the standard mobile network services such as SMS, browser alert, net alert, WAP push, and the like.

13. The method of claim 1, wherein mobile client application provides options to specify multiple recipients of the multimedia message and deliver notification messages to a group of mobile devices at the same time.

14. The method of claim 1, wherein server program code collects the information about the mobile device from the request of the mobile device on the fly. The collected information includes, but not limited to, mobile device model, MIN, user agent, requesting IP and the like.

15. The method of claim 14, wherein device info is collected on the fly via user agent profile and HTTP headers.

16. The method of claim 1, wherein the device info collected on the fly through request is used to query a device database for additional device information. This additional device information includes, but not limited to, the supported rich content formats, the display dimensions, and the like.

17. The method of claim 16, wherein a device database is provided for querying device information by device model.

18. The method of claim 1, wherein multimedia message is converted at the server into formats and dimensions that are supported by the mobile device so that they can be saved, viewed, previewed, downloaded and played on the mobile device.

19. The system of claim 1, wherein the server program code may authenticate the request to retrieve the multimedia message using mobile device numbers, the authentication of recipients further comprises
Associating the generated unique id to the mobile device numbers of recipients;
Storing the association between the unique id of multimedia message and the mobile device numbers of the recipients;
Prompting user to enter mobile device number at the time of retrieving the multimedia message;
Validating the mobile device number against the device numbers associated with unique id.

20. The system of claim 1, wherein a server for managing communications with a mobile device over a network further comprising:
Handling http request from mobile client applications running on mobile devices;
Receiving multimedia messages and saving them into multimedia message store;
Generating a unique id for each multimedia message;
Generating a link for accessing multimedia message;
Associating the link with the location of the multimedia message in a multimedia store;
Transmitting the link to the mobile device;
Handling http request from the mobile device for retrieving the multimedia message;
Collecting characteristics of the mobile device from the mobile request.
Querying device database for additional device information.
Locating the multimedia message using the link embedded in the notification message;
Converting multimedia messages to formats and dimensions supported by mobile device;
Delivering the multimedia messages to mobile devices.
